(19) United States
(12) Patent Application Publication
(10) Pub. No.: US 2006/0068631 A1
(43) Pub. Date: Mar. 30, 2006

(54) Electronic apparatus indicating electronic part mounting direction

(75) Inventors: Chikara Shimada, Takefu-city (JP); Kazuyuki Nagata, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/236,492

(22) Filed: Sep. 28, 2005

(30) Foreign Application Priority Data
Sep. 30, 2004 (JP) 2004-287521

(51) Int. Cl. H01R 3/00

(52) U.S. Cl. 439/491

(57) ABSTRACT

The present invention relates to an electronic apparatus provided with a wiring board mounted with an electronic part having a plurality of leads on its four sides, the mounting direction of which is hard to be decided, which indicates an indication symbol corresponding to a part symbol indicated on the electronic part in a predetermined direction on the wiring board and thereby indicates the mounting direction of the mounted electronic part in a visually easily recognizable manner. An indication symbol 31 is indicated by silk printing in the same direction as that of a part symbol 21 indicated on an electronic part 20 in the vicinity of the electronic part 20 mounted on a wiring board 30 and if the part symbol 21 and the symbol of the indication symbol 31 are mounted in the same direction, the electronic part 20 is decided to be mounted correctly.

The present application is based on and claims priority of Japanese patent application No. 2004-287521 filed on Sep. 30, 2004, the entire contents of which are hereby incorporated by reference.

### BACKGROUND OF THE INVENTION

1. Field of the Invention

The present invention relates to an electronic apparatus provided with a wiring board mounted with an electronic part, and more particularly, to an electronic apparatus indicating a mounting direction of an electronic part making it visually easily recognizable after the electronic part is mounted on a wiring board whether the electronic part is mounted in a correct mounting direction or not.

2. Description of the Related Art

Conventionally, as means for indicating a position and direction of an electronic part mounted on a wiring board, a method of indicating an electric symbol representing an electronic part having polarity such as a capacitor or diode on a wiring board beforehand to make it visually easily recognizable whether the electronic part has been mounted in the polarity direction as indicated or not is generally practiced.

With regard to such a method of making it visually easily recognizable whether an electronic part to be mounted or an electronic part already mounted has been mounted as indicated or not by indicating positional information for mounting the electronic part on a wiring board, for example, Japanese Utility Model Laid-Open Publication No. 58-155840 (Patent Document 1) discloses a method of adding a simple mark or a color-coded mark or the like at the position of the wiring board where the electronic part is mounted to make a specific part easily identifiable.

### SUMMARY OF THE INVENTION

According to the conventional technology, in a substantially square electronic part having a plurality of leads on its four sides, a mark indicating the position of a lead serving as a reference of a plurality of leads is impressed and a part symbol or the like of the electronic part is indicated by printing, but the positional relationship between the part symbol and the position mark of the lead serving as the reference varies from one electronic part manufacturer to another and they are not always indicated with the same positional relationship, and therefore after the electronic part is mounted on a wiring board, it is apparently difficult to decide whether the mounting direction of the electronic part is correct or not. The present invention is intended to provide an electronic apparatus indicating the mounting direction of the electronic part making it possible to easily check the mounting direction of the electronic part for which it is apparently difficult to decide whether the electronic part has been correctly mounted in a predetermined direction.

The electronic apparatus indicating a mounting direction of an electronic part according to a first aspect of the present invention is an electronic apparatus including an electronic part having a plurality of leads on four sides thereof and a wiring board on which the electronic part is mounted, wherein a mark indicating a lead position which serves as a reference out of the plurality of leads and a part symbol are indicated on the electronic part and an indication symbol corresponding to the electronic part is indicated on the wiring board by silk printing in the same direction as the indication direction of the part symbol of the electronic part when mounted.

According to the structure in the first aspect of the present invention, the electronic apparatus includes an electronic part having a plurality of leads on four sides thereof and a wiring board on which the electronic part is mounted, and a mark indicating a lead position which serves as a reference out of the plurality of leads and a part symbol are indicated on the electronic part and an indication symbol corresponding to the electronic part is indicated by silk printing in the same direction as the indication direction of the part symbol of the electronic part when mounted, as opposed to a misleading situation that the position at which the part symbol is indicated relative to a position mark of a lead serving as the reference is not always indicated in the same direction depending on the electronic part manufacturer and the mounting direction of the electronic part cannot be decided at first glance only, and therefore when the electronic part is mounted on the wiring board, if the indication direction of the part symbol of the electronic part matches the direction of the indication symbol indicated by silk printing on the wiring board, it can be decided that the mounting has been performed correctly. Thus, by only checking whether the part symbol and indication symbol are located in the same direction or not, it is possible to easily visually check whether the electronic part has been mounted correctly in a predetermined direction or not.

The electronic apparatus indicating a mounting direction of an electronic part according to a second aspect of the present invention is the electronic apparatus indicating a mounting direction of an electronic part according to the first aspect of the present invention, wherein the indication symbol is indicated at a position visually recognizable even after the electronic part is mounted on the wiring board.

According to the structure in the second aspect of the present invention, the indication symbol is indicated at a position visually recognizable even after the electronic part is mounted on the wiring board, and therefore it is possible to easily visually check whether the electronic part has been mounted correctly in a predetermined direction or not even after the electronic part is mounted on the wiring board.

The electronic apparatus indicating a mounting direction of an electronic part according to a third aspect of the present invention is the electronic apparatus indicating a mounting direction of an electronic part according to the first or second aspect of the present invention, wherein the indication symbol is indicated on the wiring board at an indication angle at which a CAD device is instructed to indicate the part symbol when the wiring board is designed.

According to the structure in the third aspect of the present invention, the indication symbol can be indicated on the wiring board at the same angle as the indication angle of the part symbol when the electronic part is mounted which has been instructed to the CAD device when the wiring board is designed, and therefore it is possible to indicate the indication symbol in a predetermined direction on the wiring board simply an unmistakably by only instructing the CAD device on the angle of the indication direction.

The electronic apparatus indicating a mounting direction of an electronic part according to a fourth aspect of the present invention is the electronic apparatus indicating a mounting direction of an electronic part according to the third aspect of the present invention, wherein the electronic part mounting device which mounts the electronic part on the wiring board comprises image recognizing means for optically reading and deciding the indication symbol indicated on the wiring board and the indication direction of the indication symbol, the part symbol indicated on the mounted electronic part and the indication direction of the part symbol.

According to the structure in the fourth aspect of the present invention, the electronic part mounting device which mounts the electronic part on the wiring board comprises image recognizing means for optically reading and deciding the indication symbol indicated on the wiring board and the indication direction of the indication symbol, the part symbol indicated on the mounted electronic part and the indication direction of the part symbol, and therefore the image recognizing means can check whether the mounting direction is correct or not and after the electronic part is mounted on the wiring board, the deciding means provided for the electronic part mounting device can optically read and decide the indication direction of the indication symbol indicated on the wiring board and the indication direction of the part symbol indicated on the mounted electronic part and it is thereby possible to check whether the electronic part has been mounted in the predetermined direction or not in the mounting stage of the electronic part easily and unmistakably.

The electronic apparatus indicating a mounting direction of an electronic part according to a fifth aspect of the present invention is the electronic apparatus indicating a mounting direction of an electronic part according to the third aspect of the present invention, wherein the electronic part mounting device which mounts the electronic part on the wiring board comprises image recognizing means for making a decision based on indication angle instruction information on the indication symbol instructed to the CAD device and optically read image information on the part symbol indicated on the mounted electronic part and the indication direction of the part symbol.

According to the structure in the fifth aspect of the present invention, the electronic part mounting device which mounts the electronic part on the wiring board comprises image recognizing means for making a decision based on indication angle instruction information on the indication symbol instructed to the CAD device and optically read image information on the part symbol indicated on the mounted electronic part and the indication direction of the part symbol, and therefore the image recognizing means can check whether the mounting direction is correct or not and after the electronic part is mounted on the wiring board, when the electronic part is mounted on the wiring board, the image recognizing means provided for the electronic part mounting device can make a decision based on the indication angle instruction information on the indication symbol instructed to the CAD device and optically read image information on the part symbol indicated on the mounted electronic part and the indication direction of the part symbol. In this way, it is possible to check whether the electronic part has been mounted correctly in the predetermined direction or not in the mounting stage of the electronic part easily and unmistakably.

### BRIEF DESCRIPTION OF THE DRAWINGS

FIG. 1 illustrates a cross-sectional view of a schematic structure of a wiring board mounted with a substantially square electronic part having leads extending from its four sides, showing an embodiment of the present invention;

FIG. 2 illustrates a state before the electronic part is mounted on the wiring board in FIG. 1 of the present invention;

FIG. 3 illustrates an indication example of an indication symbol when a CAD device is instructed to indicate another indication angle of the present invention;

FIG. 4 illustrates an indication example of an indication symbol when a CAD device is instructed to indicate a further indication angle of the present invention; and

FIG. 5 illustrates a block diagram showing the structure of the CAD device and electronic part mounting device of the present invention.

### DETAILED DESCRIPTION OF THE PREFERRED EMBODIMENTS

As shown above, the present invention is intended to basically facilitate, after an electronic part is mounted on a wiring board, the checking of the mounting direction of the mounted electronic part and in the following explanations of an embodiment, a method of allowing a check as to whether the electronic part has been correctly mounted or not according to the indication direction of an indication symbol indicated on the wiring board during mounting will also be explained.

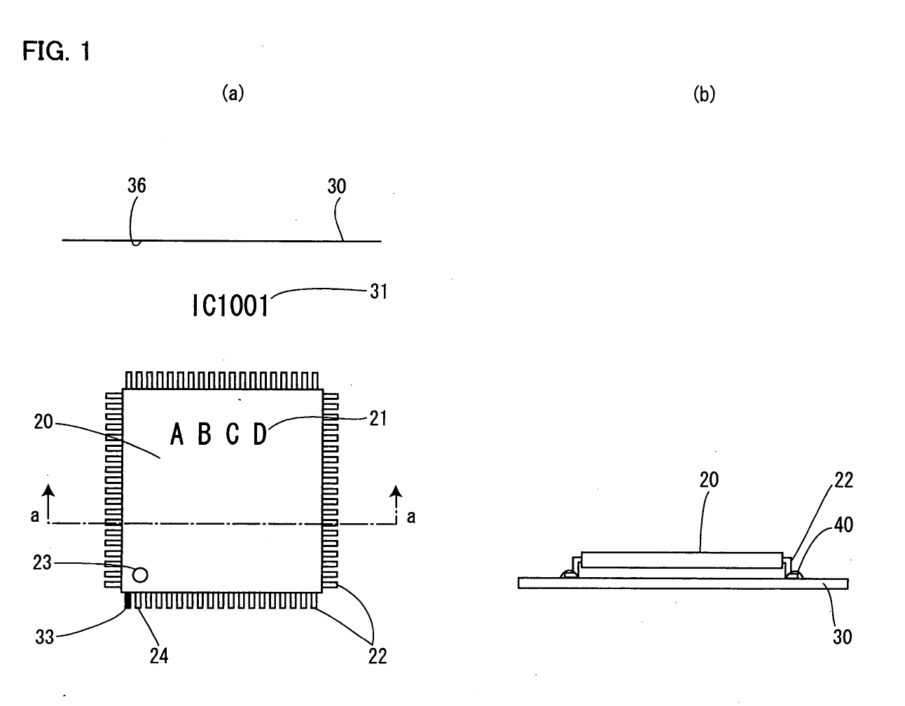

With reference now to FIG. 1 to FIG. 5, an embodiment as the best mode for implementing the present invention will be explained below. However, it goes without saying that the present invention is also easily applicable to structures other than that explained in the embodiment within a range not departing from the essence of the present invention.

FIG. 1 illustrates a cross-sectional view of a schematic structure of a wiring board mounted with an LSI of a substantially square shape generally called “QFP (Quad Flat Package)” having leads extending from its four sides as an electronic part as an embodiment of the present invention.

FIG. 1A shows that an electronic part 20 is mounted parallel to an upper edge 36 of a wiring board 30 and a plurality of leads 22 extend from four sides of the electronic part. Furthermore, as shown in FIG. 1A, a lead position mark 23 which generally serves as a reference indicating the position of a first lead 24 of the plurality of leads 22 of the electronic part 20 is impressed as a round mark in the bottom left corner of the body of the electronic part 20 and a part symbol 21 of the electronic part 20 is described horizontally as “ABCD” in the upper part of the body 20a of the electronic part 20. Next, FIG. 1B illustrates a cross section along a line a-a of the electronic part 20 shown in FIG. 1A and the leads 22 of the electronic part 20 are bonded to the wiring board 30 by solder 40. On the other hand, on the wiring board 30 shown in FIG. 1A, a reference position mark 33 is indicated by silk printing from the bottom left corner of the electronic part 20 to the underside at the position of the wiring board 30 facing the lead position mark 23 serving as a reference for the electronic part 20 in FIG. 1A. Furthermore, in FIG. 1A, an indication symbol 31 corresponding to the electronic part 20 is written horizontally as “IC1001” by silk printing in the vicinity of the upper part of the electronic part 20 mounted on the wiring board 30.

In this way, it is possible to check whether the electronic part 20 mounted on the wiring board 30 has been mounted in the mounting direction as designed or not as follows. First, it is possible to visually check whether the reference position mark 33 indicated on the wiring board 30 and the lead position mark 23 marked on the electronic part 20 serving as a reference are located at the same position or not, but as shown in FIG. 1A, the reference position mark 33 indicated on the wiring board 30 is indicated in a narrow area next to the plurality of leads 22 and there is a spatial limit even if an attempt is made to enlarge the reference position mark 33 to improve visibility. Furthermore, since the lead position mark 23 indicated on the electronic part 20 serving as a reference is a shallow mark, both marks cannot be made out easily only from appearance. Therefore, it is checked whether both the characters of the part symbol 21 which is relatively large and easy to read written horizontally as “ABCD” in the electronic part 20 and the indication symbol 31 which is relatively large and easy to read showing the electronic part 20 written horizontally as “IC10011” by silk printing in the wiring board 30 are written horizontally in the same direction or not. As a result, as shown in FIG. 1A, if both marks are written horizontally in the same direction, it is possible to easily confirm that the electronic part 20 is mounted in a predetermined correct mounting direction. Of course, the part symbol 21 written horizontally as “ABCD” in the electronic part 20 and the indication symbol 31 written horizontally as “IC1001” in the wiring board 30 are oriented in the same direction, and therefore the characters are easily legible and it is also possible to easily check whether the part is the predetermined electronic part 20 or not.

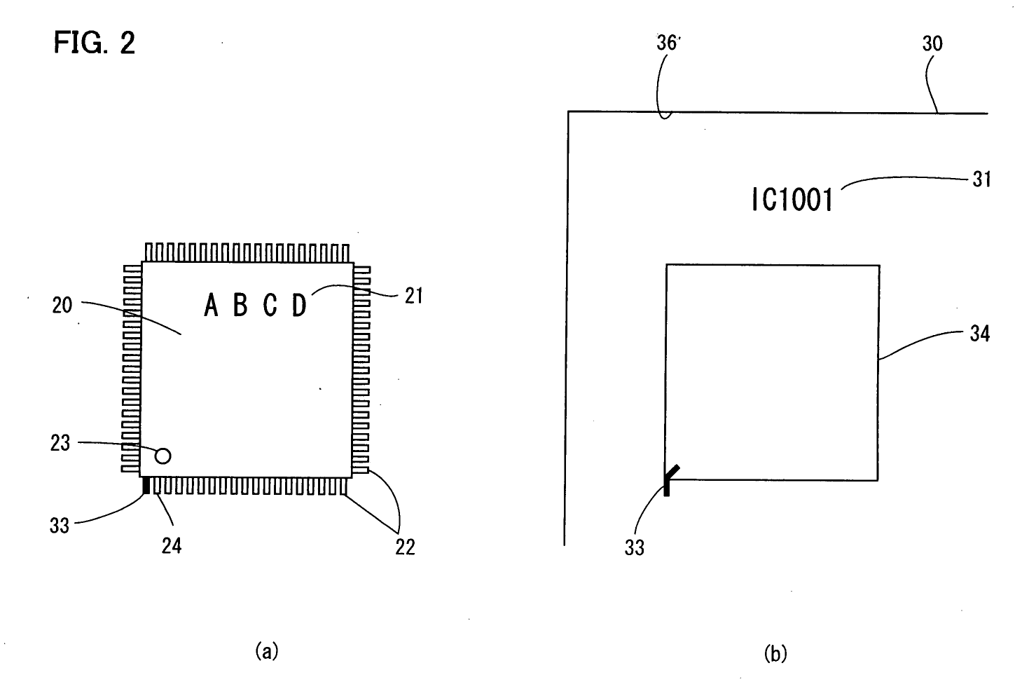

Next, FIG. 2 illustrates a state before the electronic part 20 is mounted on the wiring board 30 in aforementioned FIG. 1, FIG. 2A shows the electronic part 20 which is substantially square and has a plurality of leads 22 on its four sides and FIG. 2B illustrates the silk printing indicated on the wiring board 30. FIG. 2B omits a copper foil surface to which the leads 22 of the electronic part 20 are soldered and lands and circuit pattern or the like, formed of a resist.

For the substantially square electronic part 20 shown in FIG. 2A, a plurality of leads 22 are arranged on the four surrounding sides and the lead position mark 23 which serves as a reference indicating the position of the first lead 24 is marked as a circle at bottom left of FIG. 2A. Furthermore, the part symbol 21 is indicated as “ABCD” horizontally in the upper part of the electronic part 20.

Next, for the wiring board 30 shown in FIG. 2B, contours 34 of the mounted electronic part 20 are indicated by silk printing. Furthermore, a reference position mark 33 corresponding to the lead position mark 23 which serves as a reference indicating the position of the first lead 24 of the plurality of leads 22 arranged on the four sides of the electronic part 20 is indicated by silk printing in the bottom left corner of the contours 34 of the electronic part 20. Furthermore, the indication symbol 31 indicating the electronic part 20 with a symbol is indicated by silk printing as “IC1001” horizontally in the same direction as that of the part symbol 21 indicated in the electronic part 20 of FIG. 2A in the upper part of FIG. 2B outside the contours 34 of the electronic part 20.

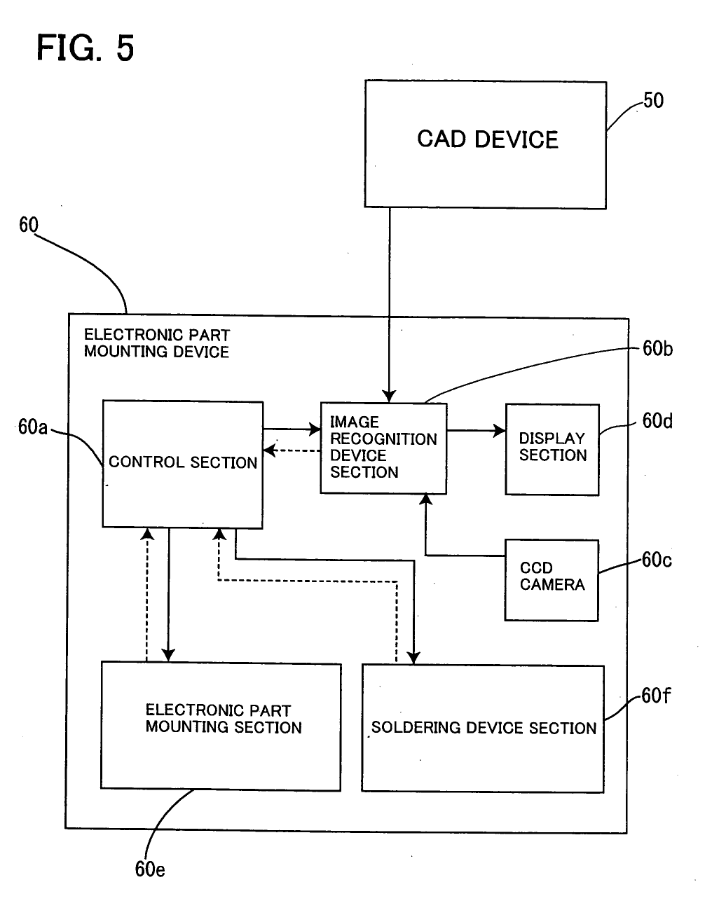

This indication symbol 31 is designed to be indicated on the wiring board 30 at an indication angle instructed by a CAD device 50 shown in FIG. 5, which instructs an indication angle of the indication symbol 31 when arranging the electronic part 20 in the stage of designing the wiring board 30. In FIG. 2B, when the upper edge 36 of the wiring board 30 is used as a reference, the indication angle of the part symbol 21 shown in FIG. 2A is 0°0 because it is written horizontally parallel to the upper edge 36 of the wiring board and the CAD device is instructed that the indication angle of the indication symbol 31 on the wiring board 30 is 0°. This causes the CAD device to indicate the symbol at an angle of 0°, that is, indicate the symbol horizontally parallel to the upper edge 36 of the wiring board 30, and therefore the indication symbol 31 of the electronic part 20 shown in FIG. 2A is indicated outside the contours 34 of the electronic part 20 at the angle instructed by the CAD device shown in FIG. 5, which allows the electronic part 20 to be visually easily recognized even after the electronic part 20 is mounted.

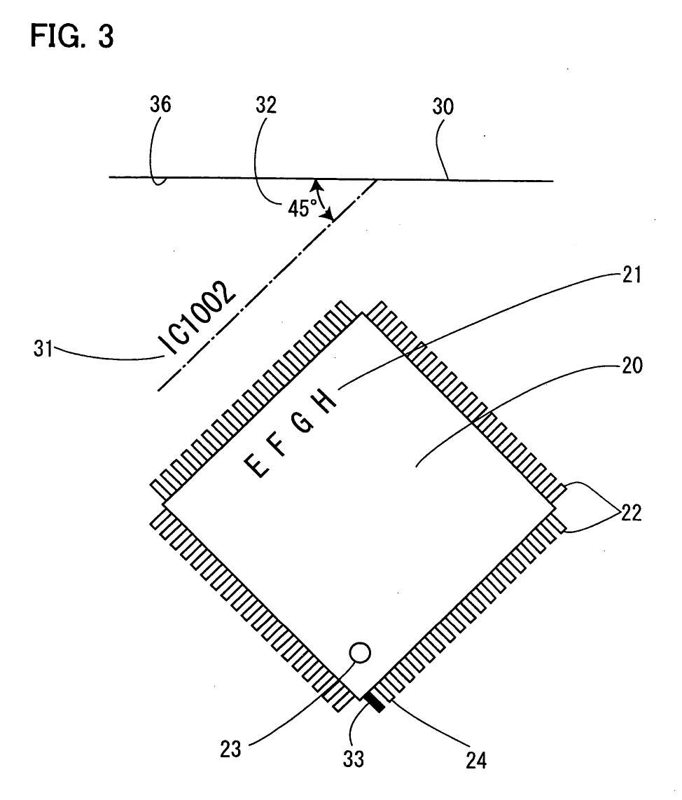

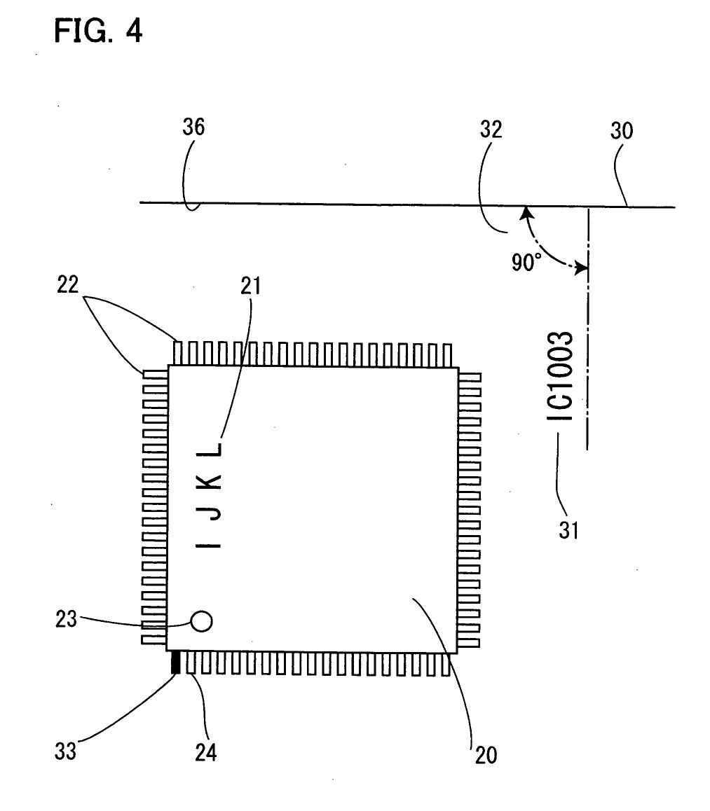

Next, in FIG. 3 and FIG. 4, other display examples where the CAD device shown in FIG. 5 instructs an indication angle to display the indication symbol 31 will be explained.

In FIG. 3, with regard to the positional relationship between the part symbol 21 and the lead position mark 23 serving as a reference of this electronic part 20, as in the cases shown in FIG. 1 and FIG. 2A, the lead position mark 23 serving as a reference is indicated in the bottom left corner with respect to the indication position of the part symbol 21. Furthermore, the electronic part 20 is mounted at an angle of 45° with respect to the upper edge 36 of the wiring board 30, and therefore the part symbol 21 indicated as “EFGH” on this electronic part 20 is also inclined to the left by 45°. Therefore, by instructing the CAD device 50 shown in FIG. 5 to indicate the indication symbol 31 as “IC1002” corresponding to the electronic part 20 at an indication angle 32 of 45°, the indication symbol 31 is indicated as “IC1002” by silk printing at an angle of 45° outside and on the left of the electronic part 20 as shown in FIG. 3, and therefore it is possible to design the wiring board 30 efficiently.

Next, the CAD device 50 and electronic part mounting device 60 shown in FIG. 5 will be explained. The electronic part mounting device 60 is provided with an electronic part mounting section 60e, a soldering device section 60f, a CCD camera 60c, an image recognition device section 60b which carries out image recognition processing on image information captured by the CCD camera 60c, a display section 60d which displays the information subjected to image recognition and a control section 60a which controls these sections. Furthermore, the image recognition device section 60b is provided with the function of capturing and processing wiring board design information such as indication angle instruction information instructed to the CAD device 50.

According to the structure of the aforementioned electronic part mounting device 60, the electronic part 20 mounted on the wiring board 30 is soldered by the soldering device section 60f provided for the electronic part mounting device 60 shown in FIG. 5, which is a flow soldering device which performs soldering through a jet flow of melted solder, the CCD camera 60c and the image recognition device section 60b provided for the electronic part mounting device 60 make out the part symbol 21 indicated as “EFGH” in the electronic part 20 and the indication symbol 31 indicated as “IC1002” on the wiring board 30, decide whether the predetermined electronic part 20 is mounted or not, the image recognition device section 60b decides whether the indication direction of the part symbol 21 matches the indication direction of the indication symbol 31 indicated as “IC1002” on the wiring board 30 or not and the display section 60d displays whether the mounting direction of the electronic part 20 is right or wrong, and therefore it is possible to easily confirm whether the mounting direction of the electronic part 20 is right or wrong.

Next, in the electronic part 20 shown in FIG. 4, the positional relationship between the part symbol 21 and the lead position mark 23 serving as a reference is different from the case shown in FIG. 1A and FIG. 2A and the lead position mark 23 serving as a reference is indicated in the top left corner with respect to the indication position of the part symbol 21. This shows an example of a case where the positional relationship between the lead position mark 23 serving as a reference and the part symbol 21 is not always the same depending on the electronic part manufacturer. In FIG. 4, the electronic part is mounted in such a way that the position of the lead position mark 23 serving as a reference matches the position of the reference position mark 33 on the wiring board 30, whereas the part symbol 21 is indicated as “IJKL” on the electronic part 20 inclined by 90° which may mislead visual judgment. Here, the CAD device 50 shown in FIG. 5 is instructed on the indication angle 32 of the same 90° as the indication angle of the part symbol 21 inclined to the left by 90° and the indication symbol 31 is indicated inclined to the left by 90° as “IC1003” by silk printing on the wiring board 30. Furthermore, the indication symbol 31 shown in FIG. 4 is indicated as “IC1003” at a location not hidden by another electronic part (not shown) around the electronic part 20, that is, close to the top right of the electronic part 20 inclined by 90° to the left. In this structure, the electronic part 20 mounted on the wiring board 30 is soldered by the soldering device section 60f which is a reflow soldering device to thermally melt cream solder provided for the electronic part mounting device 60 shown in FIG. 5, and the image recognition device section 60b provided for the electronic part mounting device 60 decides, based on the image information of the part symbol 21 captured by the CCD camera 60c provided for the electronic part mounting device 60 and the indication angle instruction information of the indication symbol 31 instructed to the CAD device 50, whether the indication direction of the indication symbol 31 indicated as “IC1003” on the wiring board 30 matches the indication angle 32 instructed to the CAD device 50 or not or whether the indication direction of the indication symbol 31 matches the indication direction of the part symbol 21 indicated as “IJKL” on the electronic part 20 or not and the display section 60d displays whether the mounting direction of the electronic part 20 is correct or not, thus making it easily recognizable whether the mounting direction is right or wrong. Furthermore, the image recognition device section 60b makes out the part symbol 21 indicated as “IJKL” on the electronic part 20 and the indication symbol 31 indicated as “IC1003” on the wiring board 30, and the display section 60d displays whether the predetermined electronic part 20 is mounted or not, thereby facilitating the checking.

As shown above, the electronic apparatus (not shown) which indicates the mounting direction of the electronic part 20 according to the present invention indicates the indication symbol 31 representing the electronic part 20 called a “QFP” having a plurality of leads 22 on its four sides on the wiring board 30 by silk printing in the same direction as the indication direction of the part symbol 21 indicated on the electronic part 20 in a visually easily recognizable manner, and can thereby easily check whether the electronic part 20 is correctly mounted in a predetermined direction or not on the wiring board 30 by carrying out a simple identification operation of checking whether the indication direction of the part symbol 21 matches the indication direction of the indication symbol 31 or not, thereby reduce the load of the work of checking the mounting direction of the electronic part 20 which is apparently hard to be distinguished by watching a screen (not shown) of the wiring board 30 when mounting the electronic part 20 and check the start of the mounting operation efficiently and speedily. Furthermore, after the mounting is completed, it is possible to reduce the load of an inspection operation of checking the mounting direction of the electronic part 20 which is apparently hard to be distinguished by watching a screen (not shown) and finish the inspection operation efficiently and speedily.

Furthermore, in the stage of designing the wiring board 30, by instructing the CAD device 50 shown in FIG. 5 on the indication angle 32 by which the indication symbol 31 is inclined with a numeric value, the indication symbol 31 is indicated in a visually easily recognizable manner by silk printing at the specified indication angle 32, and therefore it is also easy to display the indication symbol 31 with a predetermined angle of inclination with respect to the wiring board 30. Furthermore, the indication angle instruction information instructed to the CAD device 50 shown in FIG. 5 together with the image information of the indication symbol 31 captured by the CCD camera 60c shown in FIG. 5 after soldering of the electronic part 20 is subjected to image recognition processing, and the image recognition device section 60b can thereby reliably decide whether the indication symbol 31 is indicated at the same angle as the indication angle 32 of the indication symbol 31 instructed to the CAD device 50 or not or whether it is inclined in the same direction as that of the part symbol 21 of the electronic part 20 and display whether the mounting direction is right or wrong on the display section 60d. Furthermore, the image recognition device section 60b also displays on the display section 60d whether the predetermined electronic part 20 is mounted on the wiring board 30 or not, which facilitates the checking. Since the part symbol 21 is not necessarily indicated with the same positional relationship with respect to the position mark 23 of the lead serving as a reference depending on the manufacturer of the electronic part, after the electronic part 20 is mounted on the wiring board 30, the electronic part 20 can simply and reliably display the symbol in a predetermined direction by only instructing the CAD device 50 on the angle of the indication direction and efficiently design the wiring board 30, thus solving the problem that it is difficult to visually decide whether the mounting direction of the electronic part 20 is correct or not.

Furthermore, since the electronic part mounting device 60 which mounts the electronic part 20 on the wiring board 30 is provided with the image recognition device section 60b which optically reads and decides the indication symbol 31 indicated on the wiring board 30 and the indication direction of the indication symbol 31 and the part symbol 21 indicated on the mounted electronic part 20 and the indication direction of the part symbol 21, the image recognition device section 60b can check whether the mounting direction is right or wrong and after the electronic part 20 is mounted on the wiring board 30, the image recognition device section 60b of the electronic part mounting device 60 optically reads and decides the indication direction of the indication symbol 31 indicated on the wiring board 30 and the indication direction of the part symbol 21 indicated on the mounted electronic part 20 and can display them on the display section 60d, and therefore it is possible to easily and unmistakably confirm in the mounting stage of the electronic part 20 whether the electronic part 20 has been mounted correctly in the predetermined direction or not, reduce the load of the work of checking the mounting direction of the electronic part 20, efficiently perform the checking work and drastically reduce errors that problems with the mounting direction in the mounting operation are overlooked. Therefore, it is possible to drastically reduce the load in the inspection process of the wiring board. 30, improve the yield of good products of electronic apparatuses (not shown), thus contributing to a cost reduction of the electronic apparatuses.

Since the electronic part mounting device 60 which mounts the electronic part 20 on the wiring board 30 is provided with the image recognition device section 60b which decides the indication directions based on indication angle instruction information of the indication symbol 31 instructed to the CAD device 50 and image information on the part symbol 21 indicated on the mounted electronic part 20 and the optically read indication direction of the part symbol 21, the image recognition device section 60b can check whether the mounting direction is right or wrong, and therefore after the electronic part 20 is mounted on the wiring board 30, when the electronic part 20 is mounted on the wiring board 30, the image recognition device section 60b provided for the electronic part mounting device 60 can decide the indication directions based on the indication angle instruction information on the indication symbol 31 instructed to the CAD device 50 and the optically read image information on the indication direction of the part symbol 21 indicated on the mounted electronic part 20 and display the indication directions on the display section 60d. This makes it possible to easily and unmistakably check whether the electronic part 20 is correctly mounted in a predetermined direction or not in the mounting stage of the electronic part 20, reduce the load of the work of checking the mounting direction of the electronic part 20, efficiently conduct the checking work and drastically reduce errors that problems with the mounting direction in the mounting work are overlooked.

This embodiment has been explained in detail so far, but the present invention is not limited to the foregoing embodiment and can be implemented modified in various ways within a range of the essence of the present invention. For example, in the case where only the mounting direction of the electronic part 20 is checked, the image information from the CCD camera 60c in the image recognition processing only needs to be in a state in which it is possible to decide the directions of the symbol string of the part symbol 21 and the indication symbol 31. Furthermore, likewise, the indication angle 32 instructed to the CAD device 50 does not only depend on the angle with respect to the upper edge 36 of the wiring board 30 but can be selected as appropriate taking into consideration the ease of use of the CAD device 50 by which the wiring board 30 is designed without being limited to the foregoing embodiment by, for example, changing the angle with other edges of the wiring board 30.

According to the first aspect of the present invention, the electronic apparatus indicating a mounting direction of an electronic part includes an electronic part having a plurality of leads on four sides thereof and a wiring board on which the electronic part is mounted, and a mark indicating a lead position which serves as a reference out of the plurality of leads and a part symbol are indicated on the electronic part and an indication symbol corresponding to the electronic part is indicated by silk printing in the same direction as the indication direction of the part symbol of the electronic part when mounted, as opposed to a misleading situation that the position at which the part symbol is indicated relative to a position mark of a lead serving as the reference is not always indicated in the same direction depending on the electronic part manufacturer and the mounting direction of the electronic part cannot be decided at first glance only, and therefore when the electronic part is mounted on the wiring board, if the indication direction of the part symbol of the electronic part matches the direction of the indication symbol indicated by silk printing on the wiring board, it can be decided that the mounting has been performed correctly. Thus, by only checking whether the part symbol and indication symbol are located in the same direction or not, it is possible to easily visually check whether the electronic part has been mounted correctly in a predetermined direction or not and thereby reduce the load of the work of checking the mounting direction of the electronic part which is apparently hard to be distinguished by watching a screen of the wiring board when mounting the electronic part and check the start of the mounting operation efficiently and speedily.

According to the second aspect of the present invention, the indication symbol is indicated at a position visually recognizable even after the electronic part is mounted on the wiring board, and therefore it is possible to easily visually check whether the electronic part has been mounted correctly in a predetermined direction or not even after the electronic part is mounted on the wiring board and thereby reduce the load of the work of checking the mounting direction of the electronic part which is apparently hard to be distinguished by watching a screen of the wiring board after the mounting is completed and finish the inspection work efficiently and speedily.

According to the third aspect of the present invention, the indication symbol can be indicated on the wiring board at the indication angle of the part symbol instructed to the CAD device when the wiring board is designed, thus solving the problem that the positional relationship between the part symbol and the position mark of the lead serving as the reference varies from one electronic part manufacturer to another and they are not always indicated with the same positional relationship, and therefore after the electronic part is mounted on a wiring board, it is apparently difficult to decide whether the mounting direction of the electronic part is correct or not, and it is possible to indicate the electronic part in a predetermined direction simply an unmistakably by only instructing the CAD device on the angle of the indication direction.

According to the fourth aspect of the present invention, the electronic part mounting device which mounts the electronic part on the wiring board comprises image recognizing means for optically reading and deciding the indication symbol indicated on the wiring board and the indication direction of the indication symbol, the part symbol indicated on the mounted electronic part and the indication direction of the part symbol, and therefore the image recognizing means can check whether the mounting direction is correct or not and after the electronic part is mounted on the wiring board, the deciding means provided for the electronic part mounting device can optically read and decide the indication direction of the indication symbol indicated on the wiring board and the indication direction of the part symbol indicated on the mounted electronic part and it is thereby possible to check whether the electronic part has been mounted in the predetermined direction or not in the mounting stage of the electronic part easily and unmistakably, reducing the load of the work of checking the mounting direction of the electronic part, efficiently perform the checking work and drastically reduce errors that problems with the mounting direction in the mounting operation are overlooked.

According to the fifth aspect of the present invention, the electronic part mounting device which mounts the electronic part on the wiring board comprises image recognizing means for making a decision based on indication angle instruction information on the indication symbol instructed to the CAD device and optically read image information on the part symbol indicated on the mounted electronic part and the indication direction of the part symbol, and therefore the image recognizing means can check whether the mounting direction is correct or not and after the electronic part is mounted on the wiring board, when the electronic part is mounted on the wiring board, the image recognizing means provided for the electronic part mounting device can make a decision based on the indication angle instruction information on the indication symbol instructed to the CAD device and optically read image information on the part symbol indicated on the mounted electronic part and the indication direction of the part symbol. In this way, it is possible to check whether the electronic part has been mounted correctly in the predetermined direction or not in the mounting stage of the electronic part easily and unmistakably, reducing the load of the work of checking the mounting direction of the electronic part, efficiently perform the checking work and drastically reduce errors that problems with the mounting direction in the mounting operation are overlooked.

1. An electronic apparatus indicating a mounting direction of an electronic part, comprising:
an electronic part having a plurality of leads on four sides thereof; and
a wiring board on which the electronic part is mounted,
wherein a mark indicating a lead position which serves as a reference out of the plurality of leads and a part symbol are indicated on the electronic part, and
an indication symbol corresponding to the electronic part is indicated on the wiring board by silk printing in the same direction as the indication direction of the part symbol of the electronic part when mounted.

2. The electronic apparatus indicating a mounting direction of an electronic part according to claim 1, wherein the indication symbol is indicated at a position visually recognizable even after the electronic part is mounted on the wiring board.

3. The electronic apparatus indicating a mounting direction of an electronic part according to claim 1, wherein the indication symbol is indicated on the wiring board at an indication angle at which a CAD device is instructed to indicate the part symbol when the wiring board is designed.

4. The electronic apparatus indicating a mounting direction of an electronic part according to claim 3, wherein the electronic part mounting device which mounts the electronic part on the wiring board comprises image recognizing means for optically reading and deciding the indication symbol indicated on the wiring board and the indication direction of the indication symbol, the part symbol indicated on the mounted electronic part and the indication direction of the part symbol.

5. The electronic apparatus indicating a mounting direction of an electronic part according to claim 3, wherein the electronic part mounting device which mounts the electronic part on the wiring board comprises image recognizing means for making a decision based on indication angle instruction information on the indication symbol instructed to the CAD device and optically read image information on the part symbol indicated on the mounted electronic part and the indication direction of the part symbol.

6. The electronic apparatus indicating a mounting direction of an electronic part according to claim 2, wherein the indication symbol is indicated on the wiring board at an indication angle at which a CAD device is instructed to indicate the part symbol when the wiring board is designed.

7. The electronic apparatus indicating a mounting direction of an electronic part according to claim 6, wherein the electronic part mounting device which mounts the electronic part on the wiring board comprises image recognizing means for optically reading and deciding the indication symbol indicated on the wiring board and the indication direction of the indication symbol, the part symbol indicated on the mounted electronic part and the indication direction of the part symbol.

8. The electronic apparatus indicating a mounting direction of an electronic part according to claim 6, wherein the electronic part mounting device which mounts the electronic part on the wiring board comprises image recognizing means for making a decision based on indication angle instruction information on the indication symbol instructed to the CAD device and optically read image information on the part symbol indicated on the mounted electronic part and the indication direction of the part symbol.
